(19) United States
(12) Patent Application Publication
(10) Pub. No.: US 2015/0253078 A1
(43) Pub. Date: Sep. 10, 2015

(54) DEHYDRATION ASSEMBLY

(71) Applicant: TSANG-HUANG HSU, TAINAN CITY (TW)

(72) Inventor: TSANG-HUANG HSU, TAINAN CITY (TW)

(21) Appl. No.: 14/200,371

(22) Filed: Mar. 7, 2014

(51) Int. Cl. F26B 9/06

(52) U.S. Cl. CPC F26B 9/06

(57) ABSTRACT

A dehydration assembly includes a dehydration can with a space defined therein, and a ventilation tube is located in the space. The ventilation tube has a passage defined therethrough. Multiple orifices are defined through the wall of the ventilation tube so that the passage communicates with the space via the orifices. The can has multiple apertures defined through the wall thereof and the apertures communicate with the space. The heated air is guided by the ventilation tube and passes through the orifices to dry the absorbing material efficiently.

### BACKGROUND OF THE INVENTION

1. Fields of the Invention

The present invention relates to a dehydration assembly, and more particularly, to a dehydration assembly wherein the absorbing material can be quickly dried.

2. Descriptions of Related Art

The conventional dehydration assembly comprises a case with an electric heating unit located therein. Moisture absorbing material is filled in the case so as to absorb moisture in the air to reduce the humidity. When the absorbing material reaches its maximum absorbing limit, the electric heating unit is operated to generate heat to dry the absorbing material. Although the conventional dehydration assembly is able to be used repeatedly, the heating unit is located in the can and increases the weight and the cost of the dehydration assembly. Besides, the heating unit occupies the space so that the absorbing material can only be installed in the rest of space of the assembly, and this also limits the efficiency of the conventional dehydration assembly. The heating unit dries the area of the absorbing material that is located around the heating unit, the absorbing material cannot be dried completely. If the users want to dry out all of the absorbing material, the time of the operation of the heating unit has to be increased.

The present invention intends to provide a dehydration assembly wherein the absorbing material can be quickly and completely dried so as to improve the shortcomings mentioned above.

### SUMMARY OF THE INVENTION

The present invention relates to a dehydration assembly and comprises a dehydration can with a space defined therein, and a ventilation tube is located in the space. The ventilation tube has a passage defined therethrough. Multiple orifices are defined through the wall of the ventilation tube so that the passage communicates with the space via the orifices. The can has multiple apertures defined through the wall thereof and the apertures communicate with the space. The heated air is guided by the ventilation tube and passes through the orifices to dry the absorbing material efficiently.

The primary object of the present invention is to provide a dehydration assembly wherein no heating unit is installed and more material can be installed in the dehydration can.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the dehydration assembly of the present invention;

FIG. 2 is a cross sectional view of the dehydration assembly of the present invention;

FIG. 3 is an exploded view to show the second embodiment of the dehydration assembly of the present invention;

FIG. 4 is a cross sectional view of the second embodiment of the dehydration assembly of the present invention;

FIG. 5 is an exploded view to show the third embodiment of the dehydration assembly of the present invention;

FIG. 6 is a cross sectional view of the third embodiment of the dehydration assembly of the present invention;

FIG. 7 is an exploded view to show the fourth embodiment of the dehydration assembly of the present invention;

FIG. 8 is a cross sectional view of the fourth embodiment of the dehydration assembly of the present invention;

FIG. 9 is an exploded view to show the fifth embodiment of the dehydration assembly of the present invention;

FIG. 10 shows the fifth embodiment of the dehydration assembly of the present invention;

FIG. 11 is an exploded view to show the sixth embodiment of the dehydration assembly of the present invention, and

FIG. 12 shows the dehydration assembly composed of multiple sixth embodiment of the dehydration assembly of the present invention.

### DETAILED DESCRIPTION OF THE PREFERRED EMBODIMENT

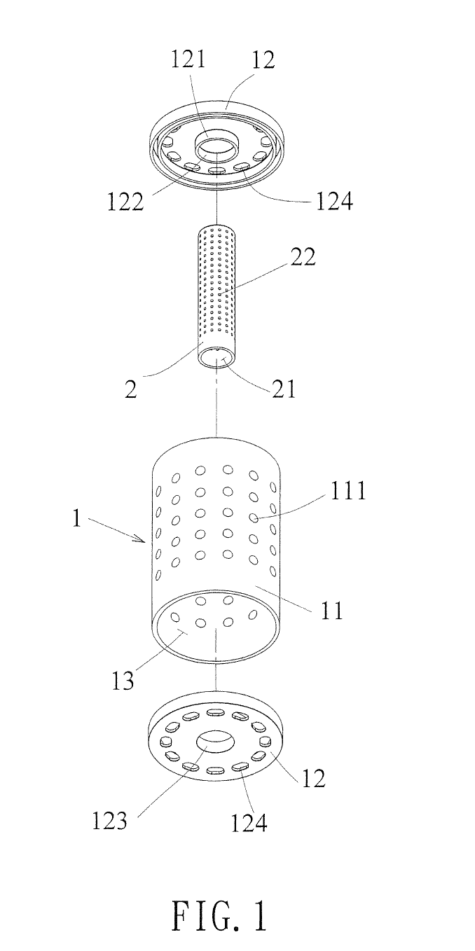

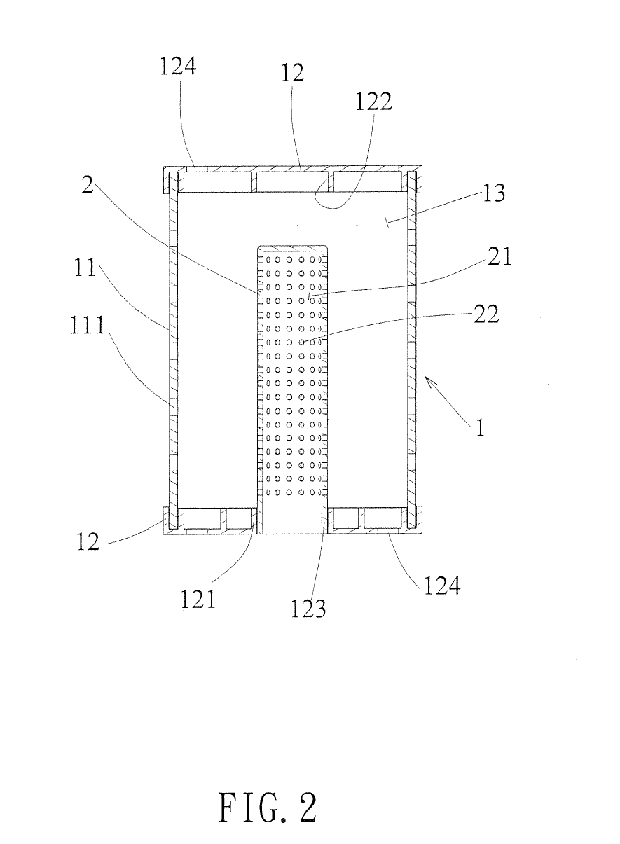

Referring to FIGS. 1 and 2, the dehydration assembly of the present invention comprises a dehydration can 1 and a ventilation tube 2.

The dehydration can 1 is a tubular case 11 which has two open ends, two covers 12 are connected to two ends of the case 11 so as to form a space 13 defined between the case 11 and the two covers 12. Each of the two covers 12 has a connection portions 121 extending from the center thereof and each connection portion 121 has a reception portion 122. One of the covers 12 has a through hole 123 defined through the reception portion 122. There are multiple apertures 111 defined through the wall of the case 11 and multiple openings 124 defined through the covers 12 so as to be in communication with the space 13.

The ventilation tube 2 is located in the space 13 and has a passage 21 defined therethrough. Multiple orifices 22 are defined through the wall of the ventilation tube 2. The passage 21 communicates with the space 13 via the orifices 22. One end of the ventilation tube 2 is connected to the reception hole 122 of one of the two covers 12. The through hole 123 communicates with the passage 21 of the ventilation tube 2.

When in use, the absorbing material in the form of particles are put in the space 13 of the dehydration can 1, and the dehydration assembly is put in the clothes closet, shoes cabinet, and book cabinets so that the moisture in the air enters into the space 13 via the apertures 111 of the case 11 and is absorbed by the absorbing material. Therefore, the humidity in the room is reduced.

Besides, when the absorbing material reaches to the maximum absorbing level, an exterior heating unit can be used to dry out the absorbing material. The heating unit is connected to the dehydration assembly and generates hot air which passes through the through hole 123 of the dehydration can 1 and enters into the passage 21 of the ventilation tube 2, and then the hot air reaches the absorbing material via the orifices 22 of the ventilation tube 2, such that the moisture in the absorbing material is released from the apertures 111 and the openings 124. The hot air can circulates in the space 13 to dry the absorbing material in the space 13.

Because the dehydration assembly of the present invention does not inherently equipped with the heating unit, the space 13 is sufficient for storage of the absorbing material, so that the absorbing efficiency is increased. In other words, the dehydration assembly can be used for a longer period of time because more absorbing material is available. The ventilation tube 2 efficiently guides the hot air of the heating unit to the space 13 to completely dry the absorbing material. Therefore, the time required that the heating unit operates is reduced, and the electric power cost is saved, and the heating unit may have longer life of use, no frequent maintenance is needed for both the dehydration assembly and the heating unit.

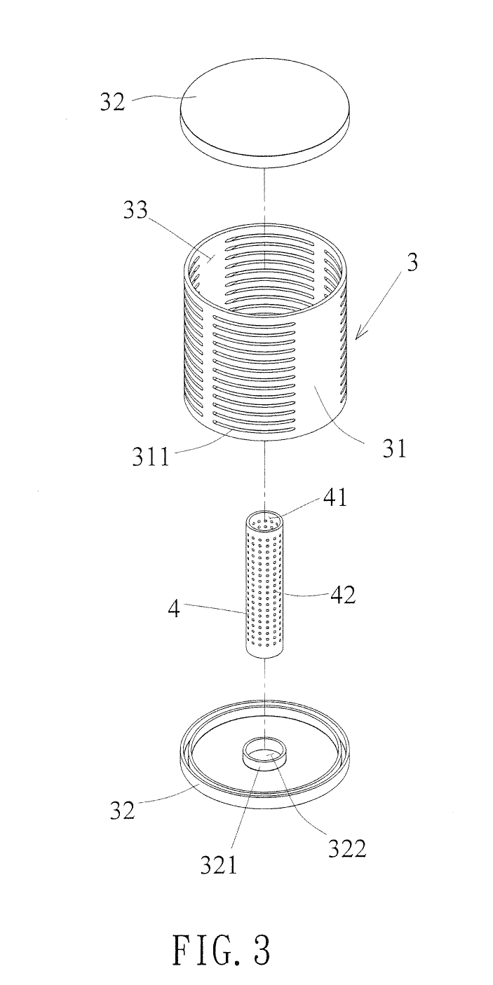

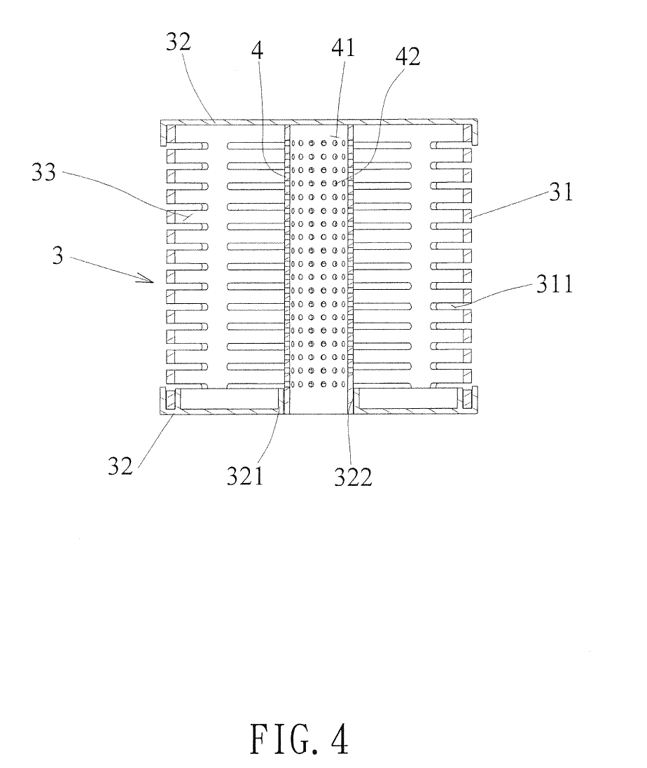

As shown in FIGS. 3 and 4, a second embodiment of a dehydration can 3 is a tubular case 31 which has two open ends, two covers 32 are connected to two ends of the case 31 so as to form a space 33 defined between the case 31 and the two covers 32. The case 31 has multiple elongate apertures 311 defined radially through the wall thereof. Each of the two covers 32 has a connection portions 321 extending from the center thereof and each connection portion 321 has a through hole 322. A ventilation tube 4 is located in the center of the space 33 in the dehydration can 3 and has two open ends. A passage 41 is defined axially through the ventilation tube 4. Multiple orifices 42 are defined through the wall of the ventilation tube 4. One end of the ventilation tube 4 is connected to the through hole 322 of one of the two covers 32. The through hole 322 communicates with the passage 41 of the ventilation tube 4. When drying the absorbing material, the heating unit is connected to the dehydration assembly and generates hot air which passes through the through hole 322 of the dehydration can 3 and enters into the passage 41 of the ventilation tube 4, and then the hot air reaches the absorbing material via the orifices 42 of the ventilation tube 4, such that the moisture in the absorbing material is released from the apertures 311 of the case 31.

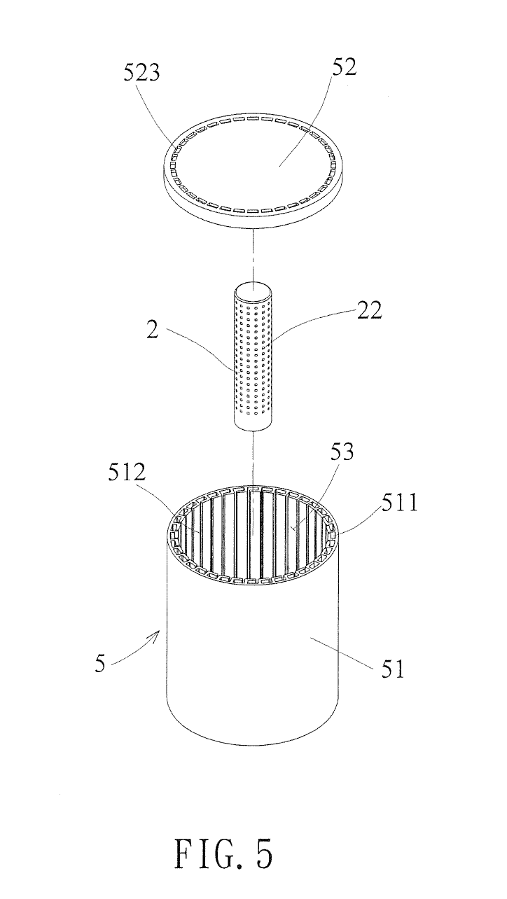

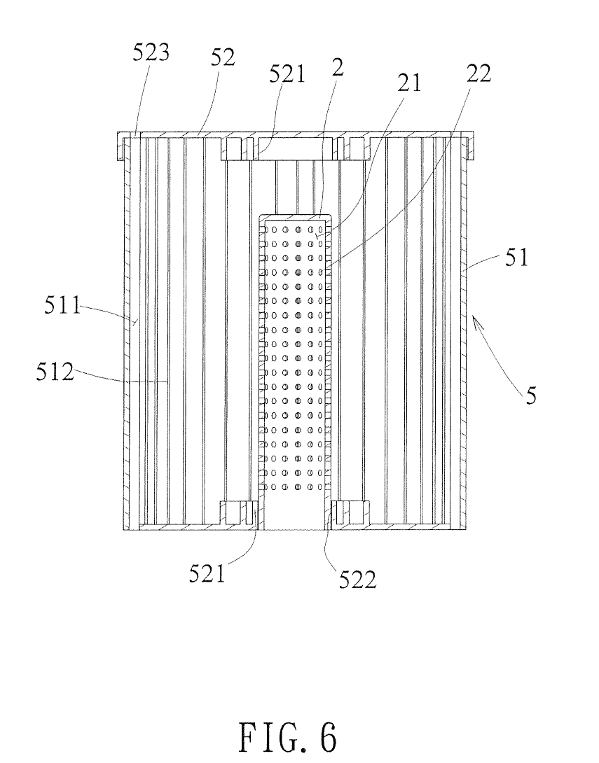

As shown in FIGS. 5 and 6, a third embodiment of a dehydration can 5 is a tubular case 51 which has one open end and one closed end. A cover 52 is connected to the open end of the case 51 so as to form a space 53 defined between the case 51 and the cover 52. The case 51 has multiple paths 511 defined axially in the wall thereof so as to form openings in the closed end. The case 51 has multiple slits 512 defined axially in the inside of the wall thereof and the slits 512 communicate with the paths 511 correspondingly. The cover 52 has openings 523 which communicate with the paths 511. The closed end of the case 51 has a connection portion 521 extending from the inside thereof and a through hole 522 is defined through the connection portion 521 so that the closed end is in communication with outside. A ventilation tube 2 is located in the center of the space 53 in the dehydration can 5 and has one open end and one closed end. The open end of the ventilation tube 2 is connected to the through hole 522 of the cover 52 so that a passage 21 of the ventilation tube 2 communicates with the through hole 522 of the cover 52.

When drying the absorbing material, the heating unit is connected to the dehydration assembly and generates hot air which passes through the through hole 522 of the dehydration can 5 and enters into the passage 21 of the ventilation tube 2, and then the hot air reaches the absorbing material via orifices 22 of the ventilation tube 2. The hot air enters into the paths 511 via the slits 512, and is released from the openings of the closed end via the paths 511, and the openings 523.

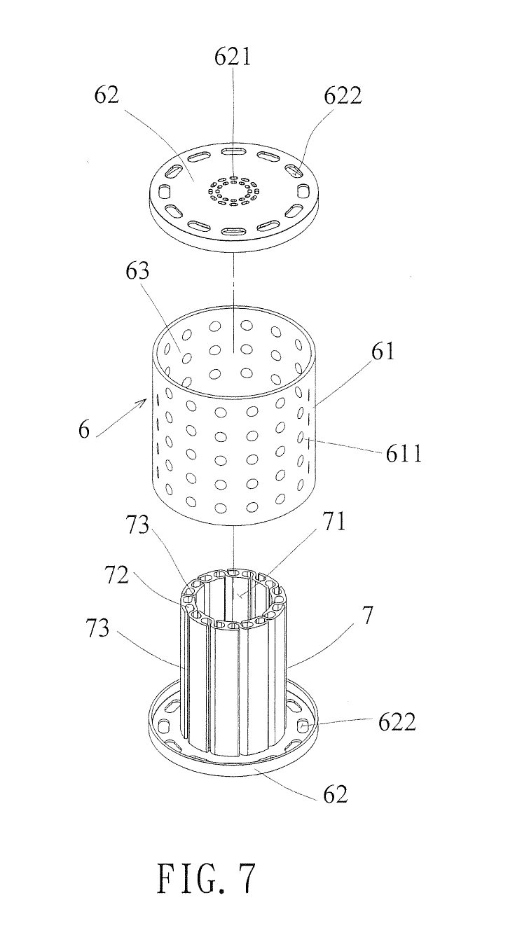

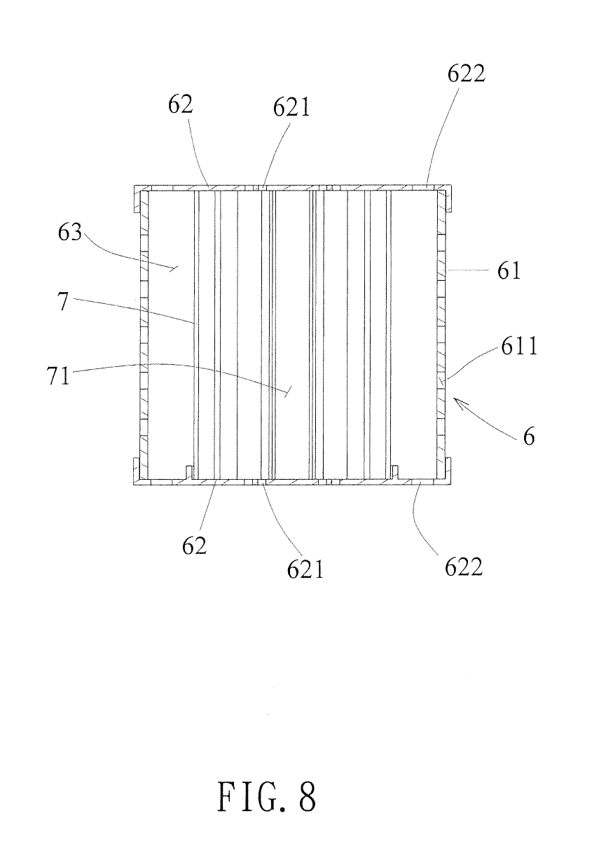

As shown in FIGS. 7 and 8, a fourth embodiment of a dehydration can 6 is a tubular case 61 which has two open ends. Two covers 62 are connected to the open ends of the case 61 so as to form a space 63 defined between the case 61 and the cover 62. The case 61 has multiple apertures 611 defined through the wall thereof. The apertures 611 communicate with the space 63. One of the covers 62 has a ventilation tube 7 extending centrally therefrom, and the other cover 62 has through holes 621 which are located corresponding to a passage 71 of the ventilation tube 7. The ventilation tube 7 has multiple paths 72 defined axially the wall thereof. The ventilation tube 7 has multiple slits 73 defined axially in the inside and the outside of the wall thereof. The slits 73 of the inside of the ventilation tube 7 are located alternatively to the slits 73 of the outside of the ventilation tube 7. The slits 73 of the inside and the outside of the ventilation tube 7 communicate with the paths 72 correspondingly. Each of the covers 62 has multiple openings 622 defined therethrough. When drying the absorbing material, the heating unit is connected to the dehydration assembly and generates hot air which passes through the through holes 621 of the dehydration can 6 and the paths 72 of the ventilation tube 7, and enters into the space 63. By the slits 73 in the inside and the outside of the ventilation tube 7, the hot air is delivered to every place of the space 63 to dry out the absorbing material. Then the hot air is released from the openings 622 of the two covers 62.

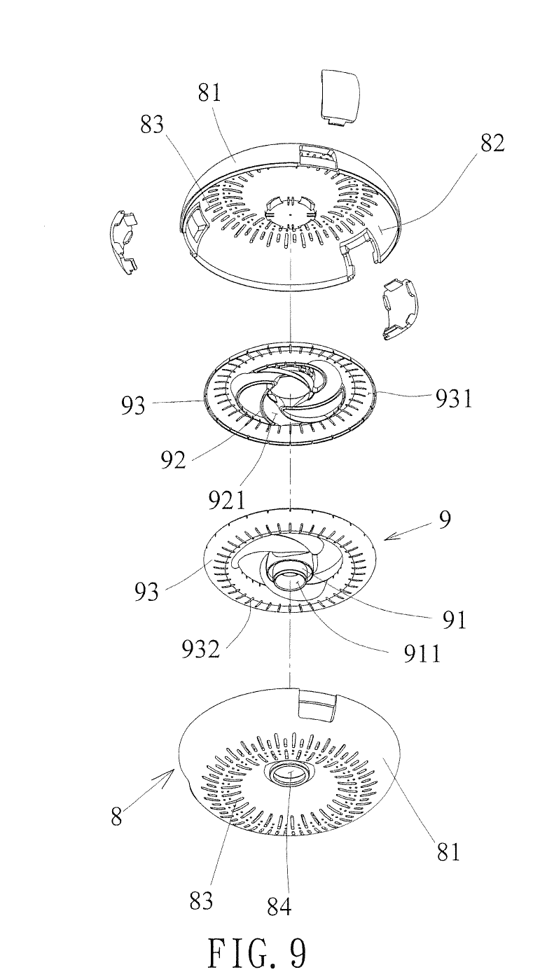

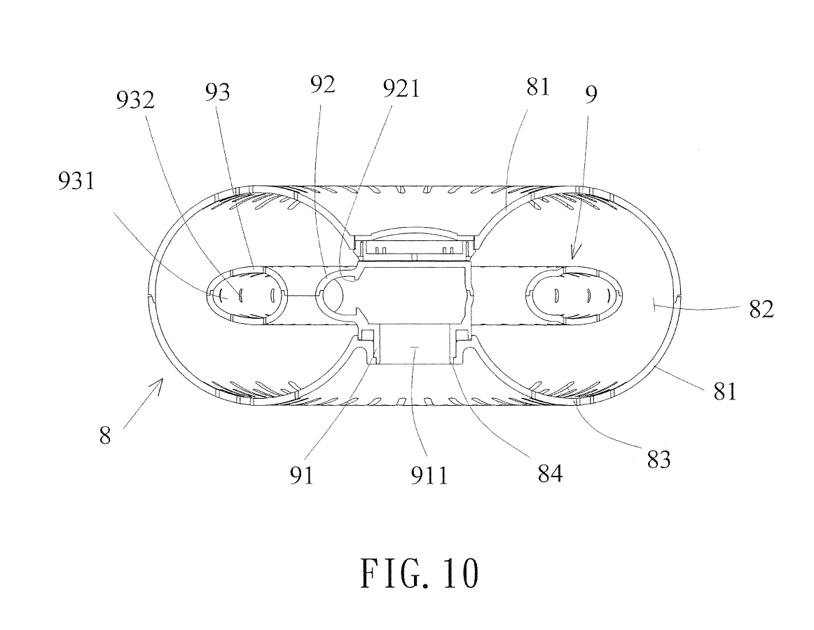

As shown in FIGS. 9 and 10, a fifth embodiment of a dehydration can 8 is composed of multiple covers 81 which are connected to each other. In this embodiment, the two covers 81 are taken as the example. A space 82 is defined between the two covers 81. Each cover 81 has multiple openings 83. A ventilation tube 9 is located in the center of the space 82 and includes a tubular portion 91 and a passage 911 is defined through the tubular portion 91. The tubular portion 91 is connected with the through hole 84 of the cover 81 so that the through hole 84 communicates with the passage 911. Multiple connection tubes 92 are connected to the tubular portion 91 and the other end of each connection tube 92 is connected with an annular guide tube 93 located along the periphery of the tubular portion 91. The guide tube 93 has multiple openings 932. The passage 911 communicates with the path 931 of the guide tube 93 via open ends 921 of the connection tubes 92. When drying the absorbing material, the heating unit is connected to the dehydration assembly and generates hot air which passes through the passage 911 of the tubular portion 91 and the open ends 921 of the connection tubes 92 so as to enter into the path 931 of the guide tube 93. The hot air reaches the space 82 of the dehydration can 8 via the openings 932 to dry out the absorbing material. Then the hot air is released from the openings 83 of the two covers 81.

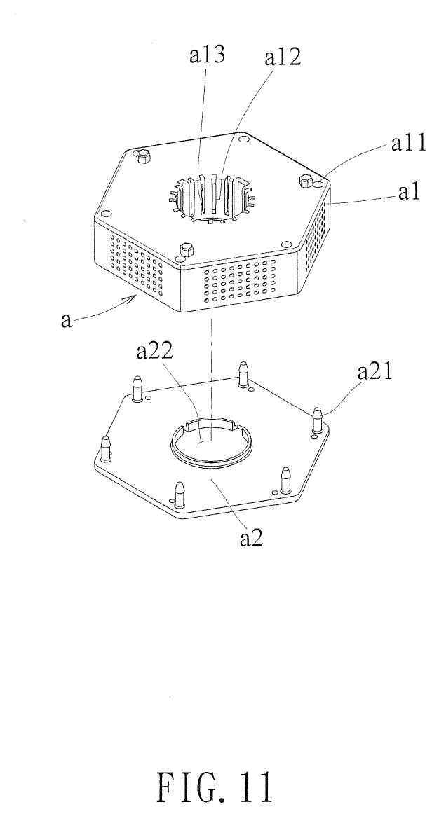

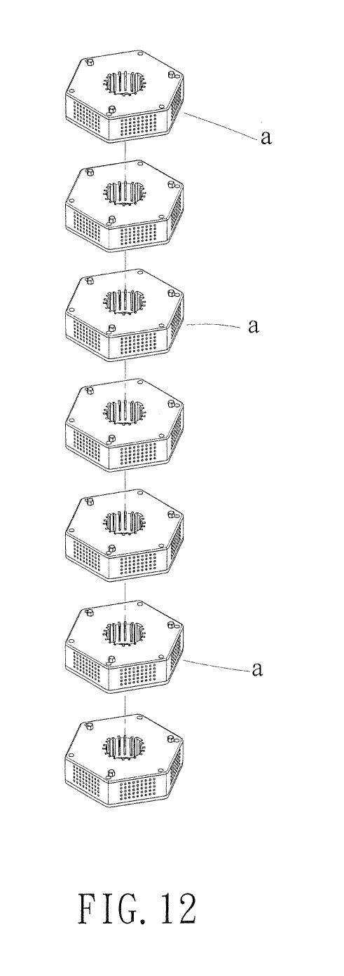

As shown in FIGS. 11 and 12, a sixth embodiment of a dehydration can “a” is a hexagonal case “a1” which has one open end and one closed end. A cover “a2” is connected to the open end and has multiple extensions “a21” extending from the inside thereof. The closed end has holes “a11” in which the extensions “a21” of the cover “a2” are inserted when the cover “a2” is connected to the open end. When drying the absorbing material, the heating unit is connected to the connected dehydration can “a” and generates hot air which passes through the through hole “a22” of the cover “a2” and enters into a space of the case “a1” dry out the absorbing material. The hot air passes through paths “a13” in the inner periphery of a central hole “a12” and reaches the through hole “A22” to dry out the absorbing material in the case “a1” above. The hot air passes through these cases “a1” one by one to dry all of the absorbing material in multiple cases “a1”.

While we have shown and described the embodiment in accordance with the present invention, it should be clear to those skilled in the art that further embodiments may be made without departing from the scope of the present invention.

What is claimed is:

1. A dehydration assembly comprising:
a dehydration can having a space defined therein, and
a ventilation tube located in the space and having a passage defined therethrough, multiple orifices defined through a wall of the ventilation tube, the passage communicating with the space via the orifices, the dehydration can having multiple apertures defined through a wall thereof, the apertures communicating with the space.

2. The dehydration assembly as claimed in claim 1, wherein the dehydration can has a case and two covers are connected to the case, the space is defined between the case and the covers, one end of the ventilation tube is connected to one of the two covers, the cover connected to the ventilation tube has a through hole which communicates with the passage of the ventilation tube.

3. The dehydration assembly as claimed in claim 1, wherein the dehydration can has a case and a cover is connected to the case, the space is defined between the case and the cover, the case has multiple paths defined axially through a wall thereof, the case has multiple slits defined axially in an inside of the wall thereof, the slits communicate with the paths correspondingly, the covers each have openings which communicate with the paths.

4. The dehydration assembly as claimed in claim 1, wherein the dehydration can has a case and two covers are connected to the case, the space is defined between the case and the covers, the ventilation tube has multiple paths defined axially through a wall thereof, the ventilation tube has multiple slits defined axially in an inside and an outside of the wall thereof, the slits of the inside of the ventilation tube are located alternatively to the slits of the outside of the ventilation tube, the slits of the inside and the outside of the ventilation tube communicate with the paths correspondingly.

5. The dehydration assembly as claimed in claim 1, wherein the dehydration can is composed of multiple covers which are connected to each other, the space is defined between the covers, one end of the ventilation tube is connected to one of the covers, the cover connected to the ventilation tube has a through hole which communicates with the passage of the ventilation tube.
